(19) United States
(12) Patent Application Publication
(10) Pub. No.: US 2019/0127194 A1
(43) Pub. Date: May 2, 2019

(54) EXCAVATOR MAN-LIFT

(71) Applicant: Clark Equipment Company, West Fargo, ND (US)

(72) Inventor: Ronald S. Hansen, Leonard, ND (US)

(21) Appl. No.: 16/179,443

(22) Filed: Nov. 2, 2018

Related U.S. Application Data
(60) Provisional application No. 62/580,747, filed on Nov. 2, 2017.

(51) Int. Cl. B66F 11/04; B66F 17/00

(52) U.S. Cl. CPC B66F 11/044; E02F 9/16; B66F 17/006

(57) ABSTRACT

A man-lift implement configured to be mounted on an implement carrier that is rotatably attached to an arm of an excavator includes an implement carrier interface configured to mount the man-lift implement to the implement carrier of the excavator, a basket configured to carry an operator, and a multi-bar linkage and a rotational actuator coupled between the implement carrier interface and the basket. The multi-bar linkage has a linkage actuator and is moveable under power of the linkage actuator to raise and lower the basket relative to the implement carrier interface, and the rotational actuator is configured to pivot the basket with respect to the implement carrier interface.

### CROSS-REFERENCE TO RELATED APPLICATION

This application claims the benefit of U.S. Provisional Application No. 62/580,747, which was filed on Nov. 2, 2017.

### BACKGROUND

This disclosure is directed toward power machines. More particularly, this disclosure is directed to a man-lift for excavator type power machines.

Power machines, for the purposes of this disclosure, include any type of machine that generates power for the purpose of accomplishing a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include excavators, loaders, utility vehicles, tractors, and trenchers, to name a few examples.

A man-lift is a structure with a basket mounted on a boom or an arm and configured to carry an operator to allow the operator to work above the ground. Commonly, a man-lift is part of a power machine or other vehicle which is dedicated for use with the man-lift. This limits the usefulness of the power machine for other purposes.

The discussion above is merely provided for general background information and is not intended to be used as an aid in determining the scope of the claimed subject matter.

### SUMMARY

A man-lift implement configured to be mounted on an implement carrier that is rotatably attached to an arm of an excavator includes an implement carrier interface configured to mount the man-lift implement to the implement carrier of the excavator, a basket configured to carry an operator, and a multi-bar linkage and a rotational actuator coupled between the implement carrier interface and the basket. The multi-bar linkage has a linkage actuator and is moveable under power of the linkage actuator to raise and lower the basket relative to the implement carrier interface, and the rotational actuator is configured to pivot the basket with respect to the implement carrier interface.

This Summary and the Abstract are provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating functional systems of a representative power machine on which embodiments of the present disclosure can be practiced.

FIG. 2 is a front left perspective view of a representative power machine in the form of an excavator on which the disclosed embodiments can be practiced.

FIG. 3 is a rear right perspective view of the excavator of FIG. 2.

FIG. 4 is a side view illustration of a representative power machine with a man-lift implement attached to an implement carrier in accordance with exemplary embodiments.

FIG. 5 is an illustration of an actuator mechanism, including a rotating hydraulic actuator, configured to pivot a man-lift basket.

FIGS. 6 and 7 are illustrations of the man-lift implement carried by a lift arm structure with the boom positioning the basket well above and below grade, respectively.

FIG. 8 is an illustration of the lift arm structure folded with a stop on the linkage of the man-lift implement engaging a dipper of the lift arm structure to prevent the basket from contacting the lift arm structure.

FIG. 9 is an illustration of a representative power machine with a man-lift implement attached to the power machine with the man-lift basket positioned below the power machine.

### DETAILED DESCRIPTION

The concepts disclosed in this discussion are described and illustrated with reference to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Disclosed embodiments include man-lift implements and mounting apparatus which are configured to mount on an implement carrier of a power machine such as an excavator. The man-lift is mechanically connected directly to the implement carrier as with any other implement that might be mounted to an excavator. The man-lift is also attached to the auxiliary hydraulics circuit on the machine and/or to an electrical connection to the power and control system on the machine. Implement carrier electrical connections such as sometimes used in loader type power machines can be used.

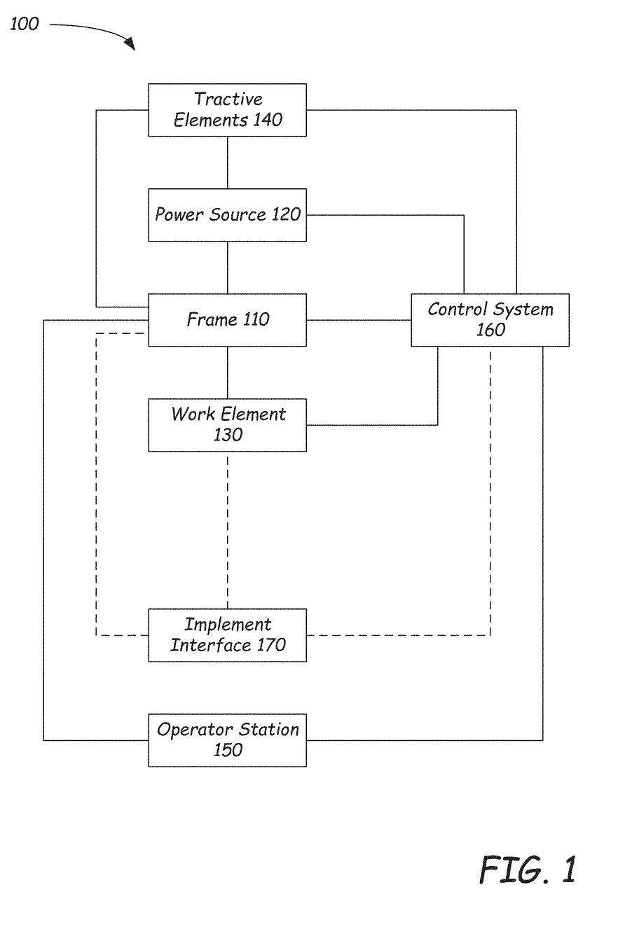

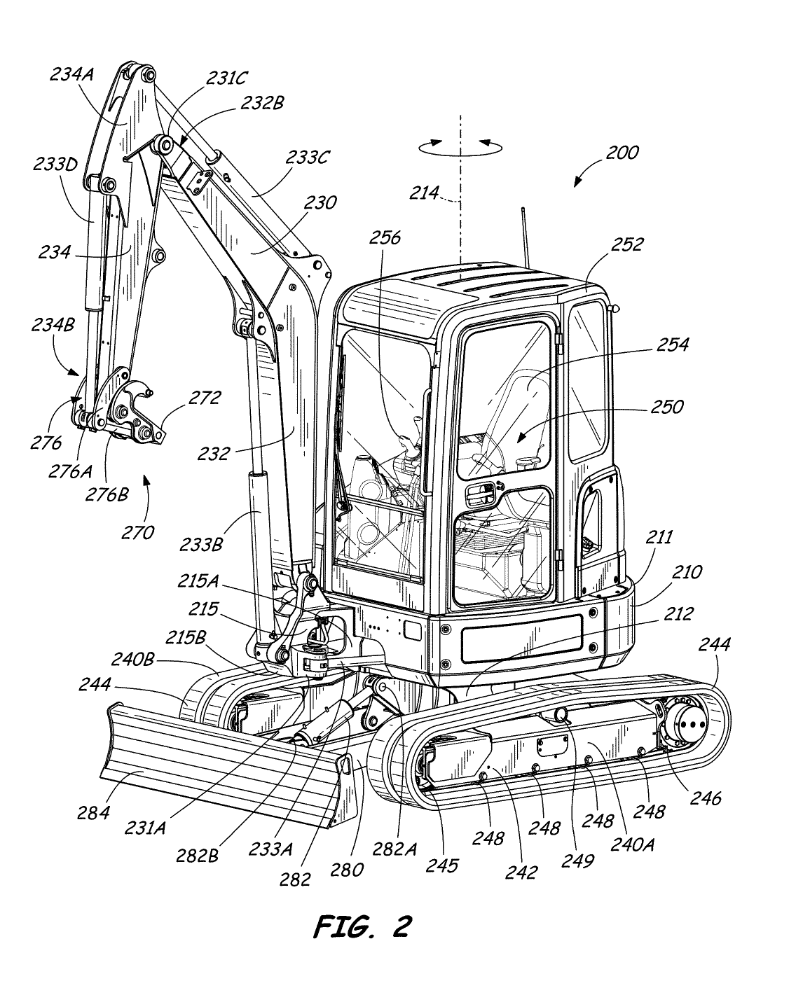

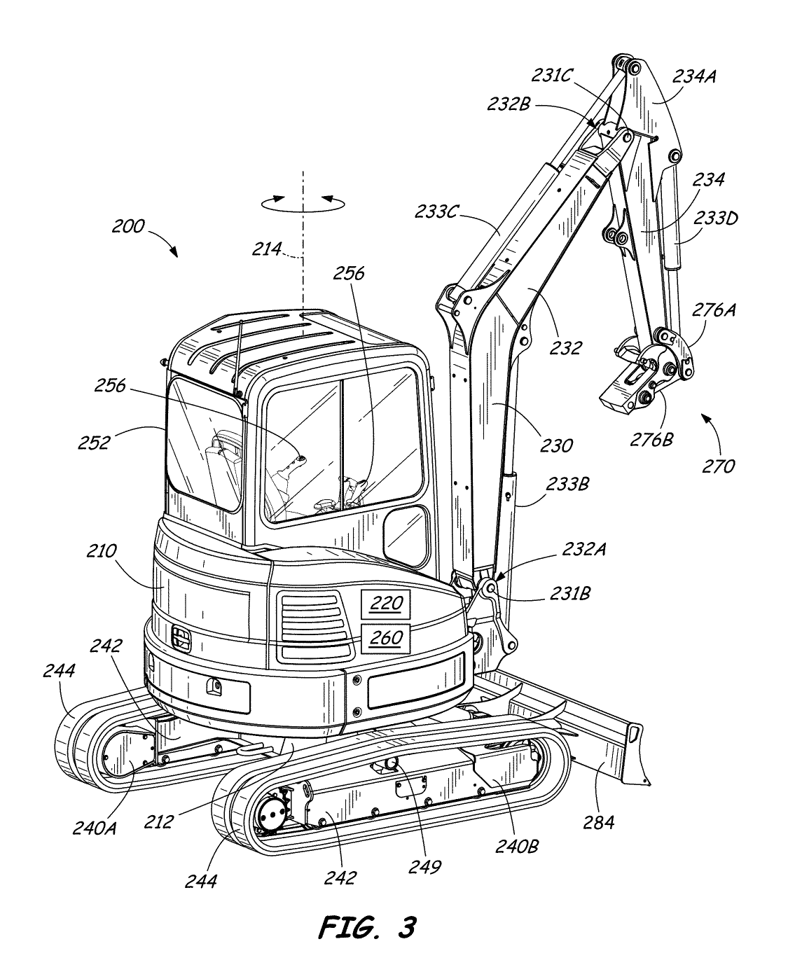

Although particularly suited for use on an excavator, the disclosed concepts can be practiced on various power machines, as will be described below. A representative power machine on which the embodiments can be practiced is illustrated in diagram form in FIG. 1 and one example of such a power machine is illustrated in FIGS. 2-3 and described below before any embodiments are disclosed. For the sake of brevity, only one power machine is discussed. However, as mentioned above, the embodiments below can be practiced on any of a number of power machines, including power machines of different types from the representative power machine shown in FIGS. 2-3. Power machines, for the purposes of this discussion, include a frame, at least one work element, and a power source that is capable of providing power to the work element to accomplish a work task. One type of power machine is a self-propelled work vehicle. Self-propelled work vehicles are a class of power machines that include a frame, work element, and a power source that is capable of providing power to the work element. At least one of the work elements is a motive system for moving the power machine under power.

Referring now to FIG. 1, a block diagram illustrates the basic systems of a power machine 100 upon which the embodiments discussed below can be advantageously incorporated and can be any of a number of different types of power machines. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator.

Certain work vehicles have work elements that are capable of performing a dedicated task. For example, some work vehicles have a lift arm to which an implement such as a bucket is attached such as by a pinning arrangement. In exemplary embodiments, a man-lift implement is attached to the lift arm as disclosed further below. The work element, i.e., the lift arm can be manipulated to position the implement for the purpose of performing the task. The implement, in some instances can be positioned relative to the work element, such as by rotating a man-lift or a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130 or more complex, as discussed below.

On some power machines, implement interface 170 can include an implement carrier, which is a physical structure movably attached to a work element. The implement carrier has engagement features and locking features to accept and secure any of a number of implements to the work element, including a man-lift in exemplary embodiments. One characteristic of such an implement carrier is that once an implement is attached to it, it is fixed to the implement (i.e. not movable with respect to the implement) and when the implement carrier is moved with respect to the work element, the implement moves with the implement carrier. The term implement carrier is not merely a pivotal connection point, but rather a dedicated device specifically intended to accept and be secured to various different implements. The implement carrier itself is mountable to a work element 130 such as a lift arm or the frame 110. Implement interface 170 can also include one or more power sources for providing power to one or more work elements on an implement. Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that is capable of moving with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which is capable of providing power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160, which in turn selectively provides power to the elements that capable of using it to perform a work function. Power sources for power machines typically include an engine such as an internal combustion engine and a power conversion system such as a mechanical transmission or a hydraulic system that is capable of converting the output from an engine into a form of power that is usable by a work element. Other types of power sources can be incorporated into power machines, including electrical sources or a combination of power sources, known generally as hybrid power sources.

FIG. 1 shows a single work element designated as work element 130, but various power machines can have any number of work elements. Work elements are typically attached to the frame of the power machine and movable with respect to the frame when performing a work task. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, wheels attached to an axle, track assemblies, and the like. Tractive elements can be rigidly mounted to the frame such that movement of the tractive element is limited to rotation about an axle or steerably mounted to the frame to accomplish steering by pivoting the tractive element with respect to the frame.

Power machine 100 includes an operator station 150, which provides a position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether or not they have operator compartments or operator positions, may be capable of being operated remotely (i.e. from a remotely located operator station) instead of or in addition to an operator station adjacent or on the power machine. This can include applications where at least some of the operator controlled functions of the power machine can be operated from an operating position associated with an implement that is coupled to the power machine. Alternatively, with some power machines, a remote control device can be provided (i.e. remote from both of the power machine and any implement to which is it coupled) that is capable of controlling at least some of the operator controlled functions on the power machine.

FIGS. 2-3 illustrate an excavator 200, which is one particular example of a power machine of the type illustrated in FIG. 1, on which the disclosed embodiments can be employed. Unless specifically noted otherwise, embodiments disclosed below can be practiced on a variety of power machines, with the excavator 200 being only one of those power machines. Excavator 200 is described below for illustrative purposes. Not every excavator or power machine on which the illustrative embodiments can be practiced need have all of the features or be limited to the features that excavator 200 has. Excavator 200 has a frame 210 that supports and encloses a power system 220 (represented in FIGS. 2-3 as a block, as the actual power system is enclosed within the frame 210). The power system 220 includes an engine that provides a power output to a hydraulic system. The hydraulic system acts as a power conversion system that includes one or more hydraulic pumps for selectively providing pressurized hydraulic fluid to actuators that are operably coupled to work elements in response to signals provided by operator input devices. The hydraulic system also includes a control valve system that selectively provides pressurized hydraulic fluid to actuators in response to signals provided by operator input devices. The excavator 200 includes a plurality of work elements in the form of a first lift arm structure 230 and a second lift arm structure 330 (not all excavators have a second lift arm structure). In addition, excavator 200, being a work vehicle, includes a pair of tractive elements in the form of left and right track assemblies 240A and 240B, which are disposed on opposing sides of the frame 210.

An operator compartment 250 is defined in part by a cab 252, which is mounted on the frame 210. The cab 252 shown on excavator 200 is an enclosed structure, but other operator compartments need not be enclosed. For example, some excavators have a canopy that provides a roof but is not enclosed A control system, shown as block 260 is provided for controlling the various work elements. Control system 260 includes operator input devices, which interact with the power system 220 to selectively provide power signals to actuators to control work functions on the excavator 200.

Frame 210 includes an upper frame portion or house 211 that is pivotally mounted on a lower frame portion or undercarriage 212 via a swivel joint. The swivel joint includes a bearing, a ring gear, and a slew motor with a pinion gear (not pictured) that engages the ring gear to swivel the machine. The slew motor receives a power signal from the control system 260 to rotate the house 211 with respect to the undercarriage 212. House 211 is capable of unlimited rotation about a swivel axis 214 under power with respect to the undercarriage 212 in response to manipulation of an input device by an operator. Hydraulic conduits are fed through the swivel joint via a hydraulic swivel to provide pressurized hydraulic fluid to the tractive elements and one or more work elements such as lift arm 330 that are operably coupled to the undercarriage 212.

The first lift arm structure 230 is mounted to the house 211 via a swing mount 215. (Some excavators do not have a swing mount of the type described here.) The first lift arm structure 230 is a boom-arm lift arm of the type that is generally employed on excavators although certain features of this lift arm structure may be unique to the lift arm illustrated in FIGS. 2-3. The swing mount 215 includes a frame portion 215A and a lift arm portion 215B that is rotationally mounted to the frame portion 215A at a mounting frame pivot 231A. A swing actuator 233A is coupled to the house 211 and the lift arm portion 215B of the mount. Actuation of the swing actuator 233A causes the lift arm structure 230 to pivot or swing about an axis that extends longitudinally through the mounting frame pivot 231A.

The first lift arm structure 230 includes a first portion, known generally as a boom 232 and a second portion known as an arm or a dipper 234. The boom 232 is pivotally attached on a first end 232A to mount 215 at boom pivot mount 231B. A boom actuator 233B is attached to the mount 215 and the boom 232. Actuation of the boom actuator 233B causes the boom 232 to pivot about the boom pivot mount 231B, which effectively causes a second end 232B of the boom to be raised and lowered with respect to the house 211. A first end 234A of the arm 234 is pivotally attached to the second end 232B of the boom 232 at an arm mount pivot 231C. An arm actuator 233C is attached to the boom 232 and the arm 234. Actuation of the arm actuator 233C causes the arm to pivot about the arm mount pivot 231C. Each of the swing actuator 233A, the boom actuator 233B, and the arm actuator 233C can be independently controlled in response to control signals from operator input devices.

An exemplary implement interface 270 is provided at a second end 234B of the arm 234. The implement interface 270 includes an implement carrier 272 that is capable of accepting and securing a variety of different implements to the lift arm 230, including a man-lift implement in accordance with disclosed embodiments. Such implements have a machine interface that is configured to be engaged with the implement carrier 272. The implement carrier 272 is pivotally mounted to the second end 234B of the arm 234. An implement carrier actuator 233D is operably coupled to the arm 234 and a linkage assembly 276. The linkage assembly includes a first link 276A and a second link 276B. The first link 276A is pivotally mounted to the arm 234 and the implement carrier actuator 233D. The second link 276B is pivotally mounted to the implement carrier 272 and the first link 276A. The linkage assembly 276 is provided to allow the implement carrier 272 to pivot about the arm 234 when the implement carrier actuator 233D is actuated.

The implement interface 270 also includes an implement power source (not shown in FIGS. 2-3) available for connection to an implement on the lift arm structure 230. The implement power source includes pressurized hydraulic fluid port to which an implement can be coupled. The pressurized hydraulic fluid port selectively provides pressurized hydraulic fluid for powering one or more functions or actuators on an implement. The implement power source can also include an electrical power source for powering electrical actuators and/or an electronic controller on an implement. The electrical power source can also include electrical conduits that are in communication with a data bus on the excavator 200 to allow communication between a controller on an implement and electronic devices on the excavator 200. It should be noted that the specific implement power source on excavator 200 does not include an electrical power source.

The lower frame 212 supports and has attached to it a pair of tractive elements 240, identified in FIGS. 2-3 as left track drive assembly 240A and right track drive assembly 240B. Each of the tractive elements 240 has a track frame 242 that is coupled to the lower frame 212. The track frame 242 supports and is surrounded by an endless track 244, which rotates under power to propel the excavator 200 over a support surface. Various elements are coupled to or otherwise supported by the track 242 for engaging and supporting the track 244 and cause it to rotate about the track frame. For example, a sprocket 246 is supported by the track frame 242 and engages the endless track 244 to cause the endless track to rotate about the track frame. An idler 245 is held against the track 244 by a tensioner (not shown) to maintain proper tension on the track. The track frame 242 also supports a plurality of rollers 248, which engage the track and, through the track, the support surface to support and distribute the weight of the excavator 200. An upper track guide 249 is provided for providing tension on track 244 and prevent the track from rubbing on track frame 242.

A second, or lower lift arm 330 is pivotally attached to the lower frame 212. A lower lift arm actuator 332 is pivotally coupled to the lower frame 212 at a first end 332A and to the lower lift arm 330 at a second end 332B. The lower lift arm 330 is configured to carry a lower implement 334. The lower implement 334 can be rigidly fixed to the lower lift arm 330 such that it is integral to the lift arm. Alternatively, the lower implement can be pivotally attached to the lower lift arm via an implement interface, which in some embodiments can include an implement carrier of the type described above. Lower lift arms with implement interfaces can accept and secure various different types of implements thereto. Actuation of the lower lift arm actuator 332, in response to operator input, causes the lower lift arm 330 to pivot with respect to the lower frame 212, thereby raising and lowering the lower implement 334.

Upper frame portion 211 supports cab 252, which defines, at least in part, operator compartment or station 250. A seat 254 is provided within cab 252 in which an operator can be seated while operating the excavator. While sitting in the seat 254, an operator will have access to a plurality of operator input devices 256 that the operator can manipulate to control various work functions, such as manipulating the lift arm 230, the lower lift arm 330, the traction system 240, pivoting the house 211, the tractive elements 240, and so forth.

Excavator 200 provides a variety of different operator input devices 256 to control various functions. For example, hydraulic joysticks are provided to control the lift arm 230, and swiveling of the house 211 of the excavator. Foot pedals with attached levers are provided for controlling travel and lift arm swing. Electrical switches are located on the joysticks for controlling the providing of power to an implement attached to the implement carrier 272. Other types of operator inputs that can be used in excavator 200 and other excavators and power machines include, but are not limited to, switches, buttons, knobs, levers, variable sliders and the like. The specific control examples provided above are exemplary in nature and not intended to describe the input devices for all excavators and what they control.

Display devices are provided in the cab to give indications of information relatable to the operation of the power machines in a form that can be sensed by an operator, such as, for example audible and/or visual indications. Audible indications can be made in the form of buzzers, bells, and the like or via verbal communication. Visual indications can be made in the form of graphs, lights, icons, gauges, alphanumeric characters, and the like. Displays can be dedicated to provide dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided.

The description of power machine 100 and excavator 200 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and more particularly on an excavator such as excavator 200, unless otherwise noted, the concepts discussed below are not intended to be limited in their application to the environments specifically described above.

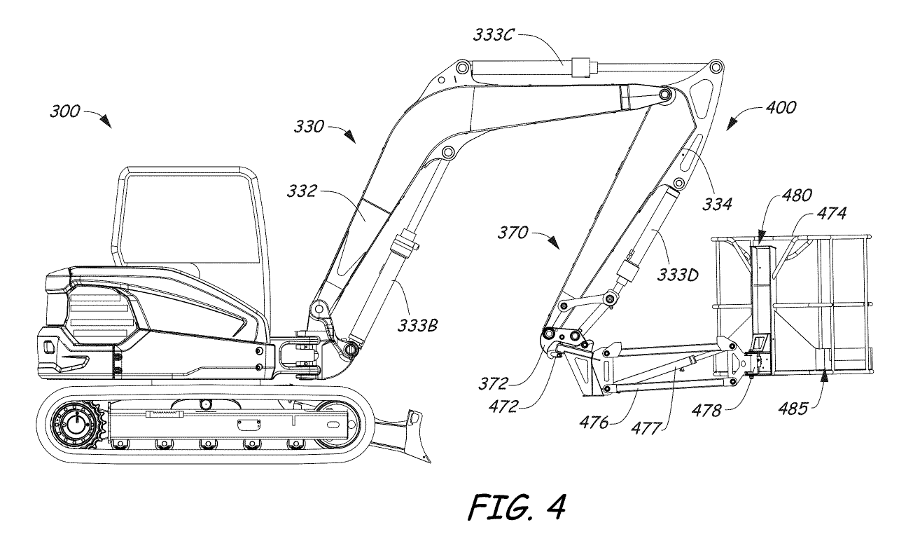

Referring now to FIG. 4, shown is an excavator power machine 300 having a lift arm structure 330 with a boom 332 and a dipper 334. An implement interface 370 at a distal end of dipper 334 includes an implement carrier 372. A man-lift implement 400 is attached to the implement carrier with an implement carrier interface 472 removably mounted on implement interface 372 of the machine.

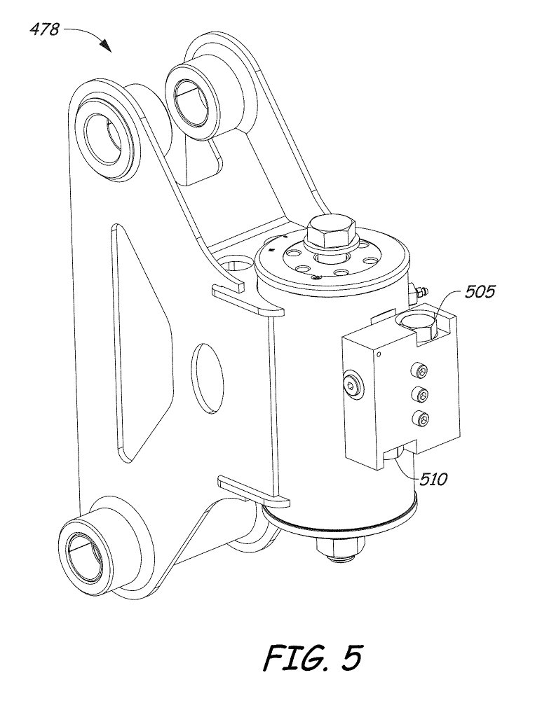

The man-lift structure has a basket 474 that is connected to the implement carrier interface 472 via a four bar linkage 476 that is moveable under power by an actuator 477, which is a hydraulic actuator in exemplary embodiments. While a four-bar linkage is shown, other multi-bar or telescopic linkages can be used instead in other embodiments. The basket 474 is pivotally mounted to the linkage 476 using a rotational hydraulic actuator 478 to allow controlled pivoting of the basket 474 with respect to the linkage 476. An embodiment of actuator 478 is shown in FIG. 5. Actuator 478 receives hydraulic power from the power machine 300 on command though hydraulic fittings 505 and 510, and functions like a hydraulic motor to rotate the basket 474. In some exemplary embodiments, using rotational hydraulic actuator 478, basket 474 can rotate approximately 90 degrees in both directions from its default or unactuated position. In other embodiments, the actuator 478 can be positioned between the linkage 476 and the implement carrier interface 472 instead of between the linkage and the basket. Alternative embodiments can incorporate a swivel and linkage geometry to allow for 360 degrees of rotation instead of +/−90 degrees of rotation.

A user interface 480 in the basket allows an operator to control the position of the basket by raising the lift arm structure 330 and manipulating the actuator(s) 477 that controls the multi-bar linkage as well as the actuator 478 that controls the pivoting or swiveling action of the basket. The user interface can control the linkage and swivel actuators by controlling the flow of auxiliary hydraulics to these actuators. A diverter valve can be provided to port a single flow to one or the other actuator so that they are never actuated simultaneously. Alternatively, two auxiliary flows (which are available on many conventional excavators) can be provided to allow the actuators to work simultaneously, or a multi-spool control valve on the man-lift can be used to accomplish the same with a single flow of auxiliary hydraulic fluid.

The user interface 480 can also be used to control the lift arm cylinders. For example, the controlled lift arm cylinders can include a swing cylinder (not shown in FIG. 4), a boom cylinder 333B, a dipper cylinder 333C and a tilt cylinder 333D. Using the user interface 480, the swing, boom, and dipper cylinders will be individually manually controlled. A level sensor 485 is provided to monitor the angle of the bucket and the tilt cylinder can be automatically controlled to maintain a level angle of the basket. The linkage cylinder 477 can also be independently controlled.

In some embodiments, the control system of power machine 400 is configured such that an automated path is implemented where a single input is used to raise and lower the basket and a controller controls all of the cylinders to raise and lower the basket along a planned path. This requires knowledge of the stroke position of each of the cylinders or the pivot angle of each of the joints. The user interface 480 can also be allowed to control travel and slew movement of the excavator. In some embodiments, the travel and slew can be accomplished with the boom at any height.

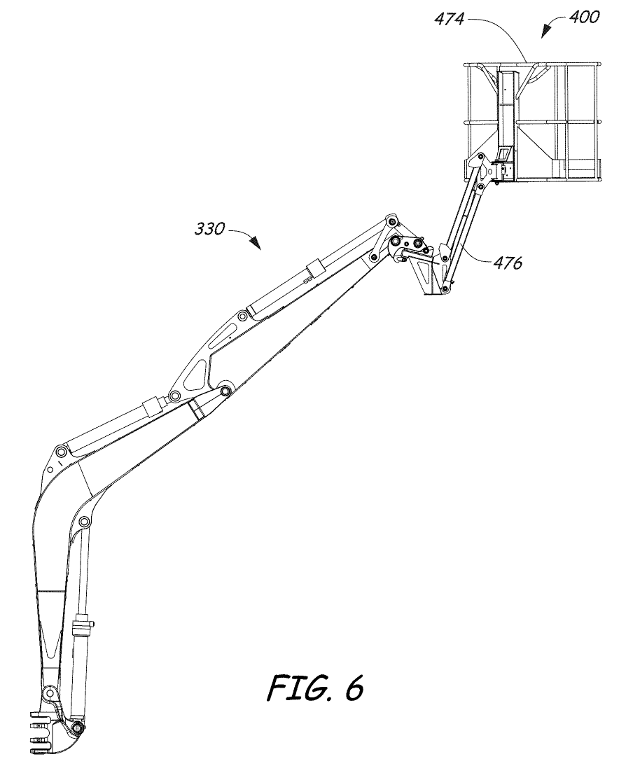

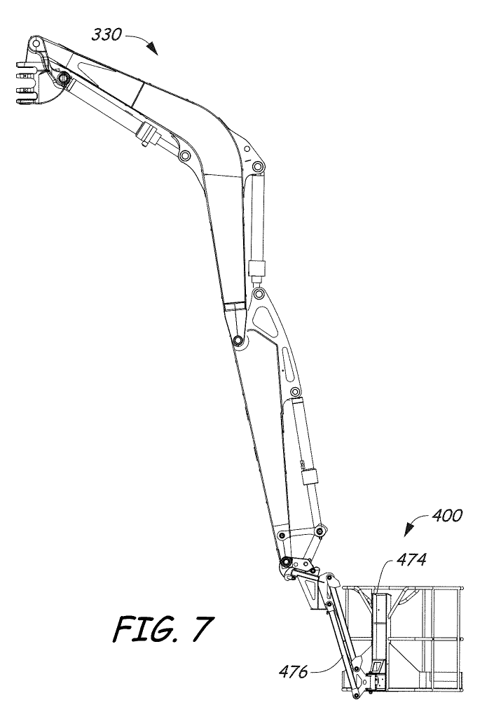

Referring now to FIGS. 6 and 7, it can be seen that the reach of the basket 474 can vary from a position well below the grade of the machine (FIG. 7) to well above the machine (FIG. 6). In embodiments in which the basket is configured to swivel 360 degrees, the basket can be positioned directly beneath the machine (for doing bridgework and the like).

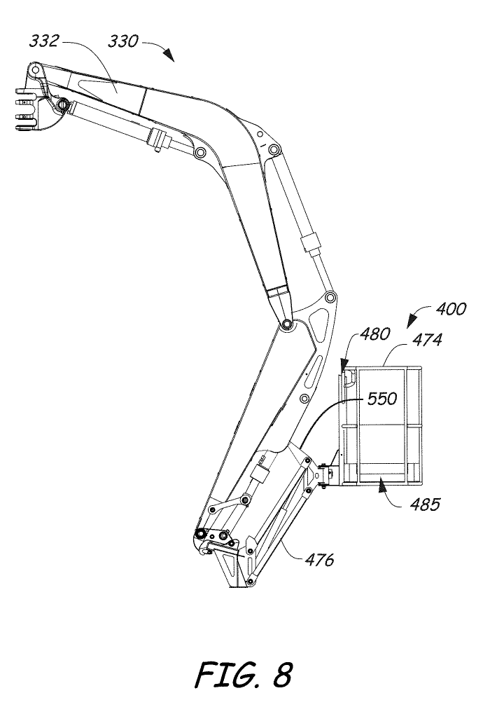

Referring now to FIG. 8, shown is man-lift implement 400 in a position with dipper 334 folded partially beneath boom 332. In exemplary embodiments, a stop 550 is included on the linkage 476 in a position which engages the dipper portion 334 of the lift arm to prevent the basket 474 from contacting the lift arm. Alternatively, with a programmed path, the basket position can be automatically controlled to avoid contact with the lift arm.

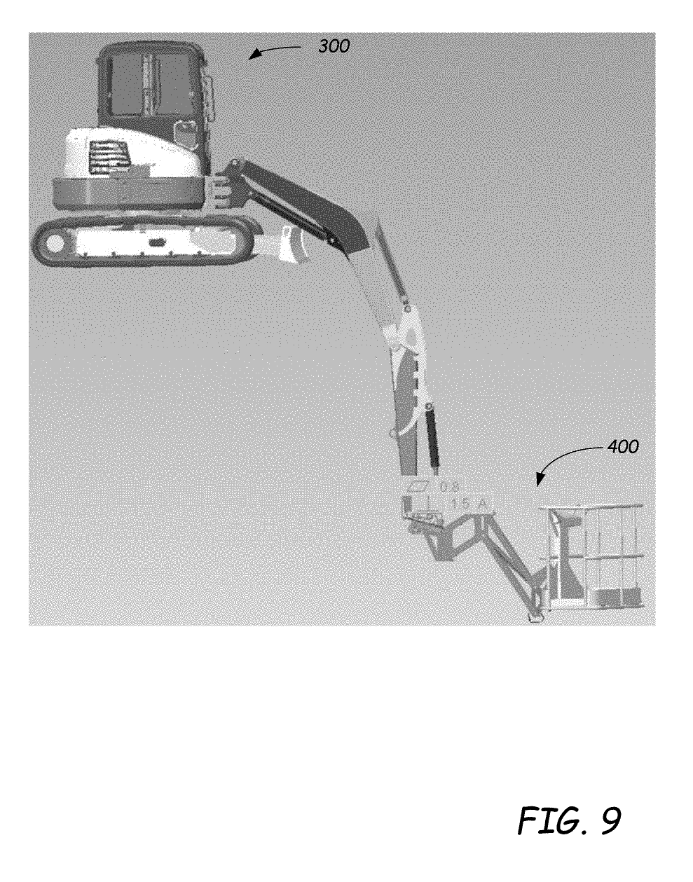

FIG. 9 illustrates power machine 300 with man-lift implement 400 attached thereto. In the FIG. 9, the man-lift implement 400 is positioned below the power machine 300 so that tasks can be performed using the man-lift implement below the grade on which the power machine is sitted. In addition, the man-lift implement, in some embodiments can rotate beneath the power machine (not shown). This can be useful, for example, when a user wants to work underneath a bridge deck. With the power machine on the bridge, the man-lift implement can be moved beneath the bridge deck.

Although the present invention has been described with reference to preferred embodiments, workers skilled in the art will recognize that changes may be made in form and detail without departing from the scope of the discussion.

What is claimed is:

1. A man-lift implement configured to be mounted on an implement carrier that is rotatably attached to an arm of an excavator, the man-lift implement comprising:
an implement carrier interface configured to mount the man-lift implement to the implement carrier of the excavator;
a basket configured to carry an operator; and
a multi-bar linkage and a rotational actuator coupled between the implement carrier interface and the basket, the multi-bar linkage having a linkage actuator and being moveable under power of the linkage actuator to raise and lower the basket relative to the implement carrier interface, and the rotational actuator configured to pivot the basket with respect to the implement carrier interface.

2. The man-lift implement of claim 1, wherein the multi-bar linkage is a four-bar linkage.

3. The man-lift implement of claim 1, and further comprising a mechanism configured to limit travel of the multi-bar linkage so as to prevent the basket from contacting the arm of the excavator.

4. The man-lift implement of claim 3, wherein the mechanism configured to limit travel of the multi-bar linkage includes a stop member configured to make contact with the arm of the excavator.

5. The man-lift implement of claim 3, wherein the mechanism configured to limit travel of the multi-bar linkage includes a sensor configured to sense the arm of the excavator.

6. The man-lift implement of claim 3, wherein the mechanism configured to limit travel of the multi-bar linkage includes a sensor configured to sense a rotational angle of at least one bar of the multi-bar linkage.

7. The man-lift implement of claim 1, wherein the multi-bar linkage is connected to the implement carrier interface and wherein the rotational actuator pivotably mounts the basket to the multi-bar linkage such that the multi-bar linkage is configured to move under power of the linkage actuator to raise and lower the rotational actuator and the basket relative the implement carrier interface, and such that the rotational actuator is configured to pivot the basket with respect to the multi-bar linkage.

8. The man-lift implement of claim 1, wherein the rotational actuator is connected to the implement carrier interface and wherein the multi-bar linkage mounts the basket to the rotational actuator such that the multi-bar linkage is configured to move under power of the linkage actuator to raise and lower the basket relative the rotational actuator, and such that the rotational actuator is configured to pivot the multi-bar linkage and the basket with respect to the implement carrier interface.

9. The man-lift implement of claim 1, and further comprising a swivel coupled between the basket and the implement carrier interface and configured to provide 360 degrees of rotation of the basket relative to the implement carrier interface.

10. The man-lift implement of claim 1, and further comprising at least one power connection configured to receive power from the excavator to power the linkage actuator and the rotational actuator.

11. The man-lift implement of claim 10, wherein the at least one power connection comprises at least one hydraulic connection.

12. The man-lift implement of claim 10, wherein the at least one power connection comprises at least one electrical connection.

13. The man-lift implement of claim 1, and further comprising at least one user input device positioned in the basket and configured to allow an operator to control a position of the basket by actuating the linkage actuator and the rotational actuator using the at least one user input device.

14. The man-lift implement of claim 13, wherein the at least one user input device is further configured to allow the operator to control the position of the basket by actuating at least one actuator on the excavator.

15. The man-lift implement of claim 14, wherein the at least one actuator on the excavator includes at least one of a swing cylinder, a boom cylinder, a dipper cylinder, and a tilt cylinder.

16. The man-lift implement of claim 14, and further comprising a level sensor configured to provide an output indicative of an angle of the basket relative to a support surface, and a controller coupled to the level sensor to receive the output and configured to responsively automatically control at least one of the linkage actuator and an actuator on the excavator to maintain a desired level angle of the basket relative to the support surface.

17. The man-lift implement of claim 16, wherein the controller is further configured to control the link actuator and the at least one actuator on the excavator to raise and lower the bucket along a substantially vertical path in response to a single user input indicating an intention to move along a vertical path.

18. The man-lift implement of claim 16, wherein the controller is further configured to control the link actuator and the at least one actuator on the excavator to raise and lower the bucket along a substantially horizontal path in response to a single user input indicating an intention to move along a horizontal path.

19. The man-lift implement of claim 1, and further comprising a stop integrated into the implement carrier interface, the stop configured to limit rotation of the implement carrier interface with respect to the excavator.
